(19) United States
(12) Patent Application Publication
(10) Pub. No.: US 2005/0058749 A1
(43) Pub. Date: Mar. 17, 2005

(54) Image exposure control in edible substrates

(75) Inventors: Benito Alberto Romanach, Mason, OH (US); LuFang Wen, Mason, OH (US)

Correspondence Address: THE PROCTER & GAMBLE COMPANY;INTELLECTUAL PROPERTY DIVISION, WINTON HILL TECHNICAL CENTER - BOX 161, 6110 CENTER HILL AVENUE, CINCINNATI, OH, 45224, US

(73) Assignee: The Procter & Gamble Company

(21) Appl. No.: 10/937,136

(22) Filed: Sep. 9, 2004

Related U.S. Application Data
(60) Provisional application No. 60/503,718, filed on Sep. 17, 2003.

(51) Int. Cl. A23G 1/00

(52) U.S. Cl. 426/138

(57) ABSTRACT

The present invention relates to articles of commerce comprising edible substrates, and more particularly to edible substrates having an image disposed thereon.

### CROSS REFERENCE TO RELATED APPLICATIONS

This application claims the benefit of priority to U.S. Provisional Application Ser. No. 60/503,718, filed Sep. 17, 2003, which is herein incorporated by reference.

### FIELD OF INVENTION

The present invention relates to articles of commerce comprising edible substrates, and more particularly to edible substrates having an image disposed thereon.

### BACKGROUND OF THE INVENTION

Printing on edible items such as snacks can provide an added level of excitement beyond the snacking itself. The printed content can be in the form of graphics, text or combinations, and it can be used to deliver, for example, games, stories, jokes, and educational facts. To obtain a desired effect, it may be necessary to time the release of portions of related information over time. For example, it may be advantageous to provide a first portion of related information, such as a question, problem, or image without revealing a second portion of related information, such as the answer, solution, or other image to allow the consumer time to think of such answer or solution by herself, or to be surprised by the other image. Consumers, however, would still require a confirmation that the answer or solution they thought of is in fact the right one. Providing first and second portions of information such that both first and second portions are viewable at the same time makes it easy for consumers to know which first and second portions go together. For example, a question may be printed on a chip and the answer may be printed below the question on the same chip. This, however, may lead to an accidental premature disclosure of the second portion of related information, like an answer or solution, which may deprive the consumer of the intellectual benefit provided by the first portion of the information.

Accordingly, it would be advantageous to provide means to accomplish information exposure control such that consumers could avoid the accidental premature disclosure of the certain information if so desired. Furthermore, it would be desirable for such methods to be simply executed so they could be easily understood by consumers. Furthermore, it would be desirable for such methods to add functionality that could further enhance the communications process.

### SUMMARY OF THE INVENTION

The present invention provides an article of commerce comprising a container and at least two edible substrates having images disposed thereon. The article of commerce can provide a means to achieve information exposure control such that consumers can avoid the premature disclosure of an image if so desired. In one aspect, the article of commerce comprises:
(a) a canister, comprising an intended canister opening; and
(b) a plurality of edible substrates contained within the canister; and
(c) a first image disposed upon a first edible substrate, wherein the first edible substrate is oriented in the canister such that the image is directed away from the intended canister opening.
   In another aspect, the article of commerce comprises:
(a) a container, comprising an intended container opening;
(b) a plurality of edible substrates contained within the container;
(c) a first image disposed upon a first edible substrate; and
(d) a second image disposed upon a second edible substrate, wherein the second image is interactively related to the first image.
   The first and second substrates can be adjacent or non-adjacent. In one embodiment, the edible substrates are oriented in the container such that the images are directed away from the intended container opening. In another embodiment, at least one intermediary substrate is located between the first and the second edible substrates.
   In still another aspect, the article of commerce comprises:
(a) a container, comprising an intended container opening;
(b) a plurality of edible substrates contained within the container, wherein the plurality of edible substrates comprises a first edible substrate having a first side and an opposing second side;
(c) a first image disposed upon the first side; and
(d) a second image disposed upon the second side, wherein the first and second images are interactively related to one-another.

In preferred embodiments, the edible substrates are fabricated snack chips.

All documents cited herein are, in relevant part, incorporated herein by reference; the citation of any document is not to be construed as an admission that it is prior art with respect to the present invention.

### BRIEF DESCRIPTION OF THE DRAWINGS

FIG. 1 presents an article of commerce including a container, snack pieces with first and second opposing sides, wherein the first side faces away from the intended container opening. FIG. 1 shows a cut-out view of the container from the side.

FIG. 2 presents an article of commerce including a container, snack pieces with first and second opposing sides, wherein the first side faces away from the intended container opening. FIG. 2 shows a cut-out view of the container from the side.

FIG. 3 presents an article of commerce including a container, snack pieces with first and second opposing sides, wherein the first side faces away from the intended container opening. FIG. 3 shows a cut-out view of the container from the side.

FIG. 4 presents an article of commerce including a container, snack pieces with first and second opposing sides, wherein the first side faces away from the intended container opening. FIG. 4 shows a cut-out view of the container from the side.

### DETAILED DESCRIPTION OF THE INVENTION

In one aspect, the present invention provides an article of commerce comprising:
(a) a canister, comprising an intended canister opening;
(b) a plurality of edible substrates contained within the canister; and
(c) a first image disposed upon a first edible substrate, wherein the first edible substrate is oriented in the canister such that the image is directed away from the intended canister opening.

In another aspect, the present invention provides an article of commerce comprising:
(a) a container, comprising an intended container opening;
(b) a plurality of edible substrates contained within the container;
(c) a first image disposed upon a first edible substrate; and
(d) a second image disposed upon a second edible substrate, wherein the second image is interactively related to the first image.

In still another aspect, the article of commerce comprises:
(a) a container, comprising an intended container opening;
(b) a plurality of edible substrates contained within the container, wherein the plurality of edible substrates comprises a first edible substrate having a first side and an opposing second side;
(c) a first image disposed upon the first side; and
(d) a second image disposed upon the second side.
   A. Container for Containing the Edible Substrate

The article of commerce comprises a container for containing the edible substrates. Any container from which the edible substrate can be dispensed, presented, displayed, or stored is suitable. Suitable containers include, but are not limited to, bags, canisters, boxes, bowls, plates, tubs, and cans. In one embodiment, the container is a canister that can contain fabricated potato crisps. In a specific embodiment, the container is a round cylindrical canister.

The container comprises an intended container opening. As used herein, “intended container opening” means the portion of the container defining the access through which a consumer is expected to remove the edibles from the container. As used herein, “consumer” includes any purchaser, potential purchaser, user, or potential user of the article of commerce.

B. Edible Substrate

As used herein, “edible substrate” or “substrate” includes any material suitable for consumption that is capable of having an image disposed thereon. Any suitable edible substrate can be used with the invention herein. Examples of suitable edible substrates can include, but are not limited to, snack chips (e.g., sliced potato chips), fabricated snacks (e.g., fabricated chips such as tortilla chips, potato chips, potato crisps), extruded snacks, cookies, candy, bread, beef jerky, crackers, pasta, sliced meats, sliced cheese, pancakes, waffles, fruit film, dried fruit film, breakfast cereals, and toaster pastries.

The edible substrate can be in any suitable form. For example, the substrate can be a finished food product ready for consumption, a food product that requires further preparation before consumption (e.g., snack chip dough, dried pasta), or combinations thereof. Furthermore, the substrate can be rigid (e.g., fabricated snack chip) or non-rigid (e.g., fruit film).

In addition, the edible substrate can include pet foods such as, but not limited to, dog biscuits and dog treats.

In a preferred embodiment, the substrate is a fried fabricated snack chip. In one embodiment, the fabricated snack chip is a potato-based fabricated snack crisp, such as that described by Lodge in U.S. Pat. No. 5,464,643, and Villagran et al. in U.S. Pat. No. 6,066,353.

C. Image Disposed upon the Edible Substrate

At least one edible substrate comprises an image disposed thereon. The image can comprise one or more text, graphic, or combinations thereof. As used herein, “text” means one or more alpha-numeric symbols. Text can include letters, numbers, words, and combinations thereof. As used herein, “graphic” means pictorial representation.

For instance, the graphic can include objects, symbols, scenes, people, animals, toys, or characters. Suitable characters can include cartoon characters and licensed characters, as well as characters associated with popular personalities in the media, advertising, or well known in the particular culture.

As used herein, “disposed on” means that one element can be integral with another element, or that one element can be a separate structure bonded to or placed on another element. Thus, the image can be applied directly or indirectly to the edible substrate, applied to a material that is placed on the edible substrate, applied within the edible substrate, or other variations or combinations thereof. In particular embodiments, the image can be printed, sprayed, or other wise applied directly on the surface of the substrate. In other embodiments, the image can be applied to a material placed on the surface of the substrate. The image can be located on the outer surface of the substrate, or can be located on the interior of the substrate, or combinations thereof.

Any suitable means of disposing an image on the substrate can be used herein. For example, the image can be printed, drawn, painted, or otherwise attached to the edible substrate. The image can be single-color or multi-color. The image can comprise dyes, pigments, other natural or synthetic substances, or combinations thereof.

In one embodiment, the image is printed on the substrate. Methods of printing can include, but are not limited to, laser, ink jet (e.g., thermal bubble jet, piezoelectric drop on demand, continuous ink jet), gravure, flexographic, and stamping.

In another embodiment, an edible sticker comprising an image is affixed to the substrate.

In another embodiment, a thin film comprising an image is affixed to the substrate via edible adhesive.

In a preferred embodiment, an ink jet image is printed on a fabricated snack chip. The image can be disposed on the chip dough before the dough is fried to make the fried fabricated snack chip, or the image can be disposed on the chip after it has been fried.

Any suitable image can be used. The image can comprise one or more graphic elements, one or more text elements, or combinations thereof. Non-limiting examples include letters, numbers, words, animals, cartoon characters, popular figures from the media, caricatures, historic events, and photographs.

Furthermore, images can be in the form of full or partial words, numbers, clues, hints, jokes, revelations, trivia quizzes, photographs, pictures, puzzles, stories, games, or sequence of events (e.g. animations). For example, the image can comprise the question portion of a trivia quiz. In one embodiment, the image depicts a piece of a jig-saw puzzle.

The image can cover part or all of the visual portion of the edible substrate. In addition, the image can include one or more images disposed upon the edible substrate.

Furthermore, the image can be permanent or active. Permanent images include those that do not change before consumption of the edible substrate. Active images include those that can be modified by some means before consumption of the edible substrate.

For example, active images include those that can be visually modified. In one embodiment, an invisible image becomes visible when the substrate comes into contact with saliva (e.g., the substrate is licked). In another embodiment, the image becomes visible when the substrate is held under a black light source. In yet another embodiment, the visible image becomes invisible when the substrate comes into contact with saliva. In still another embodiment, the visible image disappears and a second, different, image appears when the substrate comes into contact with saliva.

In a preferred embodiment, the article of commerce comprises a first image disposed upon a first edible substrate and a second image disposed upon the second edible substrate, wherein the second image is interactively related to the first image. As used herein, “interactively related” means related or associated in some way to one another such that when the interactively related images are taken together, they form a complete theme, expression, or idea. Thus, two images are interactively related if they are related or associated in some way to one another, such as, but not limited to, a question and an answer, a joke and a punch-line, or an incomplete puzzle and a missing piece.

In another embodiment, the article of commerce comprises a first image disposed upon the first side of an edible substrate and a second image disposed upon the opposing, second side of the edible substrate. Preferably, the first image and the second image are interactively related.

D. Image Exposure Control

The article of commerce can provide a means to achieve information exposure control such that consumers can avoid the premature disclosure of an image if so desired. The present invention provides image exposure control through means including: (1) use of an intermediary substrate, (2) directing the image away from the intended container opening, and (3) disposing a first image on the first side of a substrate and a second image on the opposing, second side of the substrate.

1. Intermediary Substrate

The first edible substrate can be adjacent or non-adjacent to the second edible substrate. As used herein, “adjacent” means contiguous. As used herein, “non-adjacent” means non-contiguous. Where the first and second edible substrates are non-adjacent, at least one intermediary substrate can be located between the first and second edible substrates. As used herein, “intermediary substrate” includes any edible or non-edible substrate that is located between the first and the second edible substrates in a container. For instance, intermediary substrates can include, but are not limited to, papers, films, edible substrates of the same type as the first and second edible substrates (e.g., same type of food product, such as chips), or edible substrates of a different type as the first and second edible substrates (e.g., different type of food product, such as two chips separated by a fruit film).

An intermediary substrate can have an image disposed thereon, or can be without an image disposed thereon. If the intermediary substrate comprises an image, the image can be unrelated or interactively related to the first and/or second images on the first and/or second substrates, respectively. For instance, the first image can comprise a question, the second image can comprise the answer to the question, and at least one intermediary substrate located between the first and second substrates can comprise a clue to answer the question.

2. Directed Away from the Intended Container Opening

In one embodiment, a first edible substrate is oriented in the container such that the image thereon is directed away from the intended container opening. In another embodiment, all of the edible substrates comprising images are oriented in the container such that the images thereon are directed away from the intended container opening. As used herein, “directed away from the intended container opening” means that a substrate is positioned such that the image disposed thereon is not visible when the substrate is viewed from the intended container opening.

As used herein, “not visible” means that the consumer cannot see at least part of the image.

3. Opposing Images

In yet another embodiment, the edible substrate comprises a first side and a second side that is opposed to the first side. As used herein, “opposing” or “opposed” means oriented such that the consumer cannot see at least part of the second side when viewing the first side (all the first side can be seen). In this embodiment, a first image is disposed upon the first side and a second image is disposed upon the second side. Preferably, the first image and the second image are interactively related; for instance, a question and an answer, or a joke and a punch-line. The first image is visible from the intended container opening, such that when the consumer removes the edible item from the container, the consumer can view the first image disposed thereon. The second image, however, cannot be seen until the consumer chooses to turn the edible item over to the other side to view the second image.

### EXAMPLES

The following examples are illustrative of the present invention but are not meant to be limiting thereof.

### Example 1

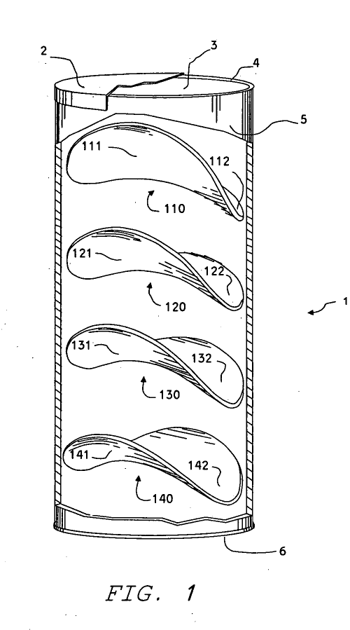

FIG. 1 depicts a representation of Example 1. It shows the article of commerce (1) comprising a cylindrical container (5), a lid (2) that covers the intended container opening (3) which is defined by a portion of the container (4). The container (5) also comprises a bottom (6), and could optionally comprise a removable membrane (not shown) affixed to the portion of the container (4). Inside the container (5) there are edible substrates (110, 120, 130 and 140), which are consistently formed to enable the formation of a stack of such edible articles that is dense and uses the space efficiently. To facilitate understanding of the figure we have only shown four edible articles outside of the densely arranged stack, but it should be understood that these edible articles can be stacked together and that many more edible articles could be made to fit in the container (5) either above edible article (110) or below edible article (140). For this example, it should also be understood that (110) is adjacent to (120), but not adjacent to (130) or (140). Analogously, (130) is adjacent to (120) and (140), but not adjacent to (110). Each of the edible articles (110, 120, 130 and 140) has an under side (111, 121, 131 and 141) respectively that faces away from the intended container opening (3), and a top side (112, 122, 132 and 142) respectively that is visible from the intended container opening (3) as the edible article above each one is removed from the container (5). In this example, images are disposed on the under sides (111, 121, 131 and 141) to control the premature exposure of an image disposed on a second edible article, as a first edible article above second edible article is removed from the container (5). In this example, each of the images disposed on the under sides (111, 121, 131 and 141) may or may not be related to one or more of these images.

### Example 2

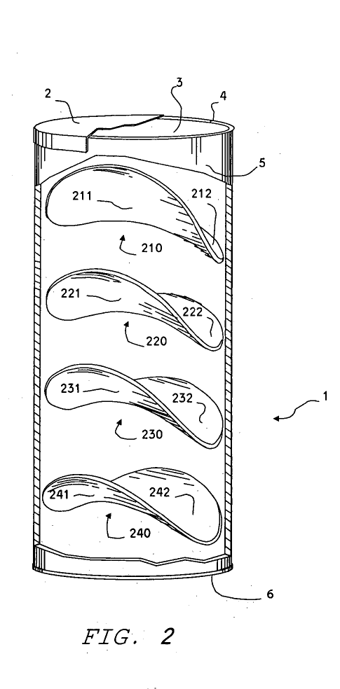

FIG. 2 depicts a representation of Example 2. It shows the article of commerce (1) comprising a cylindrical container (5), a lid (2) that covers the intended container opening (3) which is defined by a portion of the container (4). The container (5) also comprises a bottom (6), and could optionally comprise a removable membrane (not shown) affixed to the portion of the container (4). Inside the container (5) there are edible substrates (210, 220, 230 and 240), which are consistently formed to enable the formation of a stack of such edible articles that is dense and uses the space efficiently. To facilitate understanding of the figure we have only shown four edible articles outside of the densely arranged stack, but it should be understood that these edible articles can be stacked together and that many more edible articles could be made to fit in the container (5) either above edible article (210) or below edible article (240). For this example, it should also be understood that (210) is adjacent to (220), but not adjacent to (230) or (240). Analogously, (230) is adjacent to (220) and (240), but not adjacent to (210). Each of the edible articles (210, 220, 230 and 240) has an under side (211, 221, 231 and 241) respectively that faces away from the intended container opening (3), and a top side (212, 222, 232 and 242) respectively that is visible from the intended container opening (3) as the edible article above each one is removed from the container (5). In this example images are disposed on the under sides (211, 221, 231 and 241) to control the premature exposure of an image disposed on a second edible article, as a first edible article above second edible article is removed from the container (5). In this example, a first image disposed on the under side (211) of edible article (210) is related to a second image disposed on the underside (231) of edible article (230). The edible article (220) located between the edible articles (210) and (230), serves as an intermediary substrate that may or may not carry an image disposed on either under side (221) or top side (222).

In another embodiment of this example, the edible article (220) does not have an image disposed thereon and serves to increase the time while snacking between the consumer being exposed to the first image disposed on the under side (211) of edible article (210) and the related second image disposed on the underside (231) of edible article (230).

In another variation of this example, a third image is disposed on the under side (221) of edible article (220). In this example, this third image helps to prepare the user and creates anticipation towards the second image disposed on the under side (231) of edible article (230). In yet another variation of this example, the third image is unrelated to the first or second image.

### Example 3

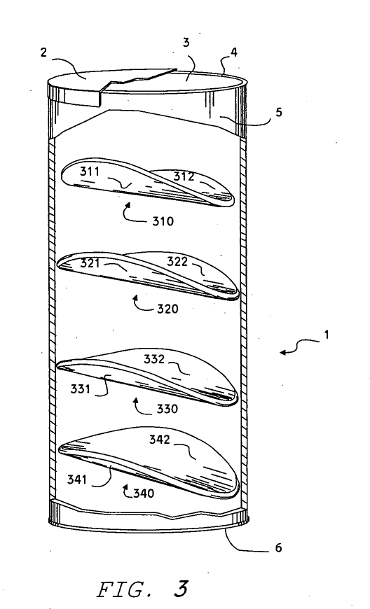

FIG. 3 depicts a representation of Example 3. It shows the article of commerce (1) comprising a cylindrical container (5), a lid (2) that covers the intended container opening (3) which is defined by a portion of the container (4). The container (5) also comprises a bottom (6), and could optionally comprise a removable membrane (not shown) affixed to the portion of the container (4). Inside the container (5) there are edible substrates (310, 320, 330 and 340), which are consistently formed to enable the formation of a stack of such edible articles that is dense and uses the space efficiently. To facilitate understanding of the figure we have only shown four edible articles outside of the densely arranged stack, but it should be understood that these edible articles can be stacked together and that many more edible articles could be made to fit in the container (5) either above edible article (310) or below edible article (340). For this example, it should also be understood that (310) is adjacent to (320), but not adjacent to (330) or (340). Analogously, (330) is adjacent to (320) and (340), but not adjacent to (310). Each of the edible articles (310, 320, 330 and 340) has an under side (311, 321, 331 and 341) respectively that faces away from the intended container opening (3), and a top side (312, 322, 332 and 342) respectively, that is visible from the intended container opening (3) as the edible article above each one is removed from the container (5). In this example images are disposed on the top sides (312, 322,332 and 342). In this example, a first image disposed on the top side (312) of edible article (310) is related to a second image disposed on the top side (332) of edible article (330). The edible article (320) located between the edible articles (310) and (330), serves as an intermediary substrate that may or may not carry an image disposed on either under side (321) or top side (322).

In another embodiment of this example, the edible article (320) does not have an image disposed thereon and serves to increase the time while snacking between the consumer being exposed to the first image disposed on the top side (312) of edible article (310) and the related second image disposed on the top side (332) of edible article (330).

In yet another variation of this example, a third image is disposed on the top side (322) of edible article (320). In this example, this third image helps to prepare the user and creates anticipation towards the second image disposed on the top side (332) of edible article (330). In yet another variation of this example, the third image is unrelated to the first or second image.

### Example 4

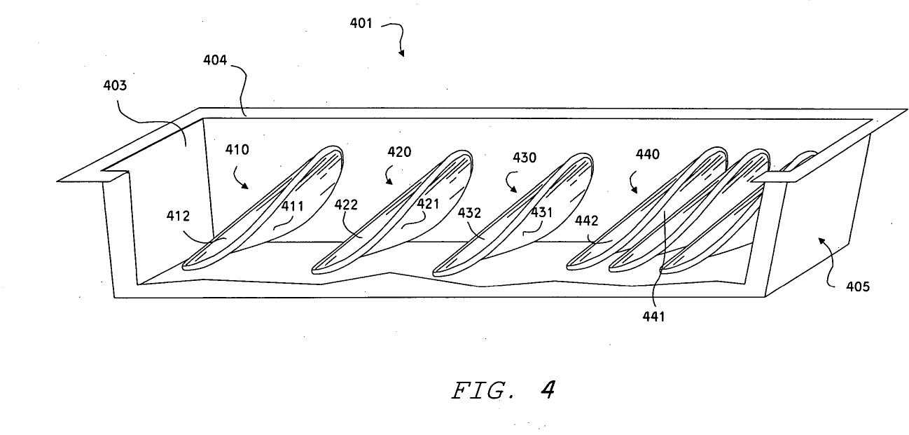

FIG. 4 depicts a representation of Example 4. It shows the article of commerce (401) comprising a tray container (405), the intended container opening (403), which is defined by a portion of the container (404). The container (405) could optionally comprise a removable membrane (not shown) affixed to the portion of the container (404). The container (405) could optionally be inserted in a plastic or metallized bag or other structure not shown. Inside the container (405) there are edible substrates (410, 420, 430 and 440), which are consistently formed to enable the formation of a stack of such edible articles that is dense and uses the space efficiently. To facilitate understanding of the figure we have only identified four edible articles outside of the densely arranged stack, but it should be understood that these edible articles can be stacked together and that many more edible articles could be made to fit in the container (405) either to the left of edible article (410) or to the right of edible article (440) (some shown). For this example, it should also be understood that (410) is adjacent to (420), but not adjacent to (430) or (440). Analogously, (430) is adjacent to (420) and (440), but not adjacent to (410). Each of the edible articles (410, 420, 430 and 440) has an under side (411, 421, 431 and 441) respectively that faces away from the intended container opening (403), and a top side (412, 422, 432 and 442) respectively that is visible from the intended container opening (403) as the edible article above each one is removed from the container (405). In this example images are disposed on the under sides (411, 421, 431 and 441) to control the premature exposure of an image disposed on a second edible article, as a first edible article above second edible article is removed from the container (405). In this example, each of the images disposed on the under sides (411, 421, 431 and 441) may or may not be related to one or more of these images.

While particular embodiments of the present invention have been illustrated and described, it would be obvious to those skilled in the art that various other changes and modifications can be made without departing from the spirit and scope of the invention. It is therefore intended to cover in the appended claims all such changes and modifications that are within the scope of this invention.

1. An article of commerce comprising:
(a) a container, comprising an intended container opening;
(b) a plurality of edible substrates contained within said container;
(c) a first image disposed upon a first edible substrate; and
(d) a second image disposed upon a second edible substrate, wherein said second image is interactively related to the first image.

2. The article of claim 1, wherein said first edible substrate is adjacent to said second edible substrate.

3. The article of claim 1, wherein said first edible substrate is not adjacent to said second edible substrate.

4. The article of claim 3, wherein at least one intermediary substrate is located between said first and the second edible substrates.

5. The article of claim 4, wherein said intermediary substrate is edible.

6. The article of claim 4, wherein said intermediary substrate is non-edible.

7. The article of claim 4, wherein at least one said intermediary substrate has an image disposed thereon.

8. The article of claim 4, wherein at least one said intermediary substrate does not have an image disposed thereon.

9. The article of claim 7, wherein at least one image disposed upon said intermediary substrate is interrelated to at least one image selected from the group consisting of said first image and said second image.

10. The article of claim 1, wherein said first substrate and said second substrate are oriented such that said first and second images are not visible from the intended container opening.

11. An article of commerce comprising:
(a) a canister, comprising an intended container opening; and
(b) a plurality of edible substrates contained within said canister; and
(c) a first image disposed upon a first edible substrate, wherein said first edible substrate is oriented in the canister such that the image is directed away from the intended container opening.

12. An article of commerce comprising:
(a) a container, comprising an intended container opening;
(b) a plurality of edible substrates contained within said container, wherein said plurality of edible substrates comprises a first edible substrate having a first side and an opposing second side;
(c) a first image disposed upon said first side; and
(d) a second image disposed upon said second side.

13. The article of commerce of claim 12 wherein the first image and the second image on the first edible substrate are interactively related with one-another.
